(19) United States
(12) Patent Application Publication
(10) Pub. No.: US 2018/0196262 A1
(43) Pub. Date: Jul. 12, 2018

(54) VIRTUAL REALITY SYSTEM

(71) Applicant: Artavious Cage, Tchula, MS (US)

(72) Inventor: Artavious Cage, Tchula, MS (US)

(21) Appl. No.: 15/862,636

(22) Filed: Jan. 5, 2018

Related U.S. Application Data
(60) Provisional application No. 62/445,554, filed on Jan. 12, 2017.

(51) Int. Cl. G02B 27/01; A63F 13/212; G06F 3/01; H04N 21/414; G06T 19/00; A63F 13/235

(52) U.S. Cl. CPC G02B 27/017; A63F 13/212; A63F 13/235; H04N 21/414; G06T 19/003; G06F 3/011

(57) ABSTRACT

A virtual reality system including an eyewear piece, handheld controller, and charging station. The eyewear piece includes an SD card slot and a plurality of lights. The charging station charges a battery of the system and includes a USB port on the back side of the charging station. The system is configured to play movies and video games. The eyewear piece includes internal speakers and control buttons and an outside monitor. Also included are lights that include a red light to indicate when a power source is being supplied to the eyewear piece, a green light to indicate battery life of the eyewear piece, a light blue light to indicate BLUETOOTH connection, and a dark blue light to indicate a Wi-Fi connection. Included are dimmer controls, an external speaker, and microphone, and camera. The handheld controller is wirelessly connected to the eyewear piece.

### CROSS-REFERENCE TO RELATED APPLICATION(S)

The present application is related to and claims priority to U.S. Provisional Patent Application No. 62/445,554 filed Jan. 12, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of computer graphics processing and selective visual display systems of existing art, and more specifically relates to an operator body-mounted heads-up display (e.g., helmet mounted display).

### Related Art

Virtual reality is a computer technology that uses headsets or multi-projected environments, images, sounds, and/or other sensations that simulate a user's physical presence in a virtual/imaginary environment. A person using virtual reality equipment is able to view the artificial images. The effect is commonly created by headsets consisting of head-mounted eyewear with a screen, but can also be created through specially designed spaces with multiple large screens. Virtual reality systems that include transmission of vibrations and other sensations to the user through a game controller or other devices are known as haptic systems. This tactile information is generally known as force feedback in medical, video gaming, and military training applications.

One limitation of the current virtual reality concept is that they are generally limited to gaming and/or must be wiredly connected to a computer or similar device with limited memory. Also, virtual reality is generally excludes the ability to view movies or other similar related visual imagery. It is advantageous for a virtual reality device to have the ability to display movies and be a ‘stand-alone’ device with removable and replaceable memory, which is not found in the prior art. Therefore, a suitable solution is required.

U.S. Pub. No. 2016/0063919 to Christopher D. Prest, et al. relates to a head-mounted display. The described head-mounted display includes a goggle system for providing a personal media viewing experience to a user is provided. The goggle system may include an outer cover, a mid-frame, optical components for generating the media display, and a lens on which the generated media displayed is provided to the user. The goggle system, or head mounted display, may have any suitable appearance. For example, the goggle system may resemble ski or motorcycle goggles. To enhance the user's comfort, the goggle system may include breathable components, including for example breathable foam that rests against the user's face, and may allow the user to move the display generation components for alignment with the user's eyes. In some embodiments, the goggle system may include data processing circuitry operative to adjust left and right images generated by the optical components to display 3-D media, or account for a user's eyesight limitations.

### SUMMARY OF THE INVENTION

In view of the foregoing disadvantages inherent in the known an operator body-mounted heads-up display art, the present disclosure provides a novel virtual reality system. The general purpose of the present disclosure, which will be described subsequently in greater detail, is to provide an efficient and effective virtual reality system.

A virtual reality system for watching movies and playing video games is disclosed herein. The virtual reality system for watching movies and playing video games includes an eyewear piece, a handheld controller, and a charging station.

The eyewear piece includes a slot configured to house a secure digital (e.g., “SD”) card, with the eyewear piece including a plurality of lights located on a front side of the eyewear piece. The handheld controller includes a plurality of buttons configured to control multiple play modes of movies and video games. The charging station is configured to charge at least one battery of the virtual reality system and includes a universal serial bus (i.e., “USB”) port located in the back side of the charging station, with the charging station having a charging indicator light located on the top surface of the charging station configured to provide a charge status of the battery (e.g., level of charge, etc.). The virtual reality system is configured to allow a user to watch movies, play music, and play video games.

The SD card preferably contains one or more movies, musical tracks, and one or more video games, and/or other media. Also, the SD card player includes a stand removably attached to a top of the SD card player, and the stand includes a plurality of stand-sensors and a light.

The eyewear piece also includes a plurality of internal speakers housed within the eyewear piece configured to allow sound to reach the user or other individuals in proximity of the eyewear piece. Also, eyewear piece preferably includes a plurality of control buttons, and is adjustable to fit a size of a head of the user. Further, the eyewear piece preferably includes a compartment in the back side of the eyewear piece configured to house the battery.

The eyewear piece also includes an outside monitor configured to allow people other than the user of the eyewear piece to watch movies and video games. Also included in the eyewear piece is a plurality of lights which preferably includes a red light configured to indicate when a power source is being supplied to the eyewear piece, a green light configured to indicate battery life of the eyewear piece, a light blue light configured to indicate a short range radio protocol (e.g., “BLUETOOTH”) connection, and a dark blue light configured to indicate a wireless (i.e., Wi-Fi) connection. The short range radio protocol capabilities include connection to other external device worn by an individual other than a use (e.g., external headphones, etc.). The eyewear piece is connectable Internet connectable either by the wireless capabilities and/or a wired connection. Also, the device includes the ability to download and save mobile applications.

The eyewear piece preferably includes a plurality of dimmer controls, with the plurality of dimmer controls including a plus button and a minus button configured to adjust the intensity of brightness of the monitor. Additionally, the eyewear piece includes an external speaker configured to allow people other than the user of the eyewear piece to listen to a sound of the movies and the video games (e.g., individuals in proximity to the eyewear piece).

The eyewear piece also includes a microphone, with the microphone configured to allow the user to interact with the video games. Further, the eyewear piece includes a camera located on the front side of the eyewear piece configured to take pictures and record video media. The eyewear piece includes an eject button located on the top surface of the eyewear piece configured to eject the SD card upon action from the user. The handheld controller is wirelessly connected to the eyewear piece. The handheld controller includes a plurality of sensors.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a virtual reality system, constructed and operative according to the teachings of the present disclosure.

FIG. 1 is a perspective view of the virtual reality system, according to an embodiment of the disclosure.

FIG. 2 is a perspective view of the virtual reality system of FIG. 1, according to an embodiment of the present disclosure.

FIG. 3 is a perspective view of the virtual reality system of FIG. 1, according to an embodiment of the present disclosure.

FIG. 4 is a perspective view of the virtual reality system of FIG. 1, according to an embodiment of the present disclosure.

FIG. 5A is a perspective view of the virtual reality system of FIG. 1, according to an embodiment of the present disclosure.

FIG. 5B is a perspective view of the virtual reality system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an operator body-mounted heads-up display (e.g., helmet mounted display) and more particularly to a virtual reality system as used to improve the use of virtual reality for gaming and video viewing by a user.

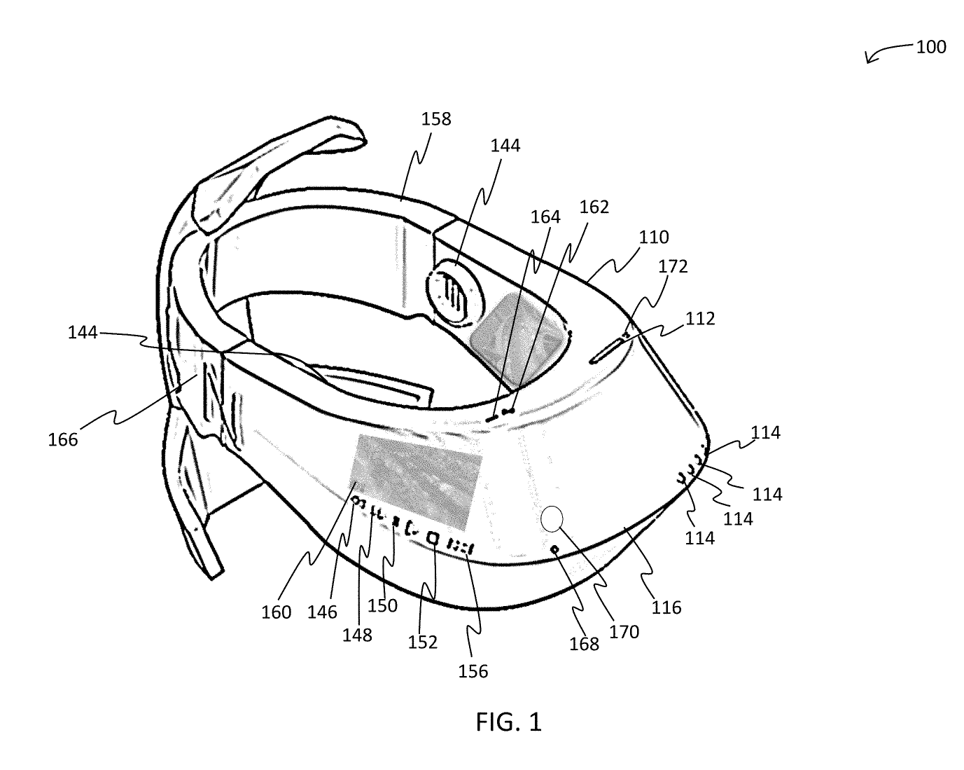

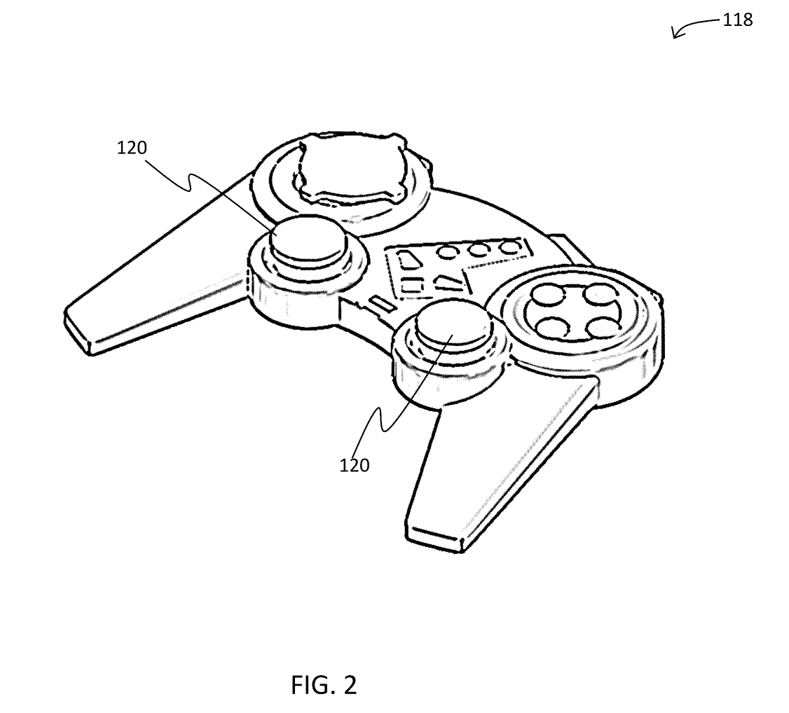

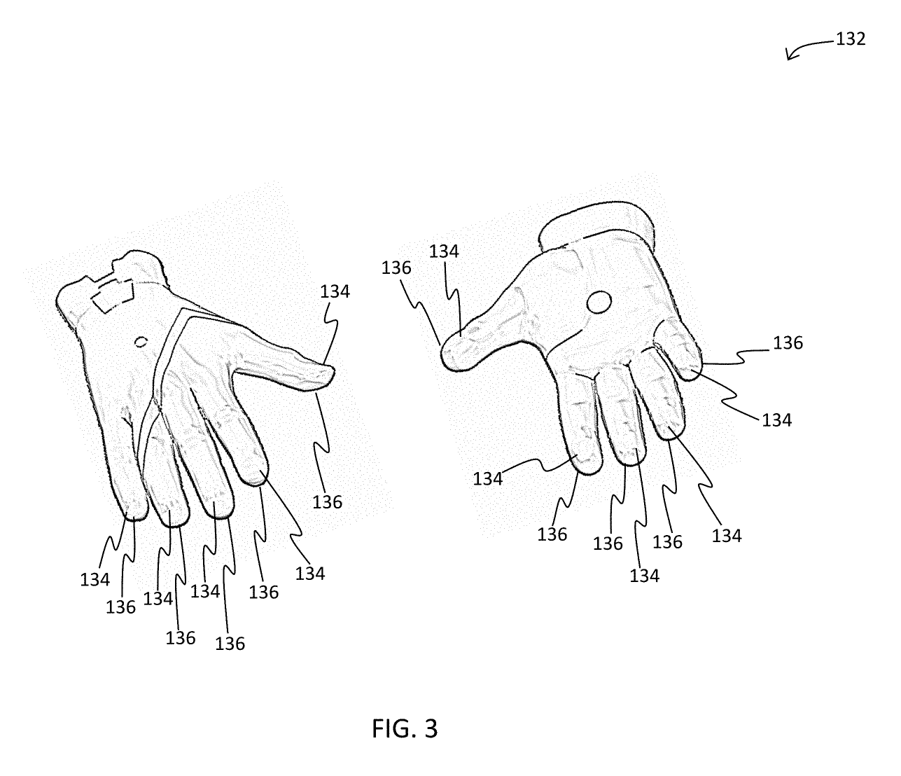

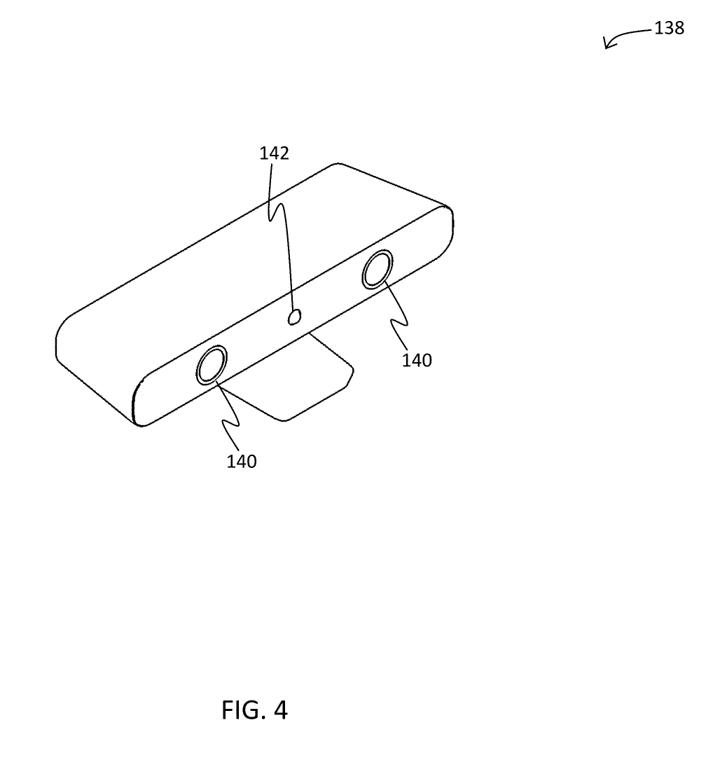

Referring now more specifically to the drawings by numerals of reference, there is shown in FIGS. 1-4, various views of a virtual reality system 100.

FIG. 1 shows a virtual reality system 100 during an ‘in-use’ condition 50, according to an embodiment of the present disclosure. Here, virtual reality system 100 may be beneficial for use by one or more user(s) 40 to provide a user with a system to interactively play electronic games, listen to music, and view videos. As illustrated, the virtual reality system 100 may include eyewear piece 110, handheld controller 118, and charging station 122,

According to one embodiment, virtual reality system 100 may be arranged as a kit 105. In particular, the virtual reality system 100 may further include a set of instructions 107. The instructions 105 may detail functional relationships in relation to the structure of virtual reality system 100 such that the virtual reality system 100 can be used, maintained, or the like, in a preferred manner.

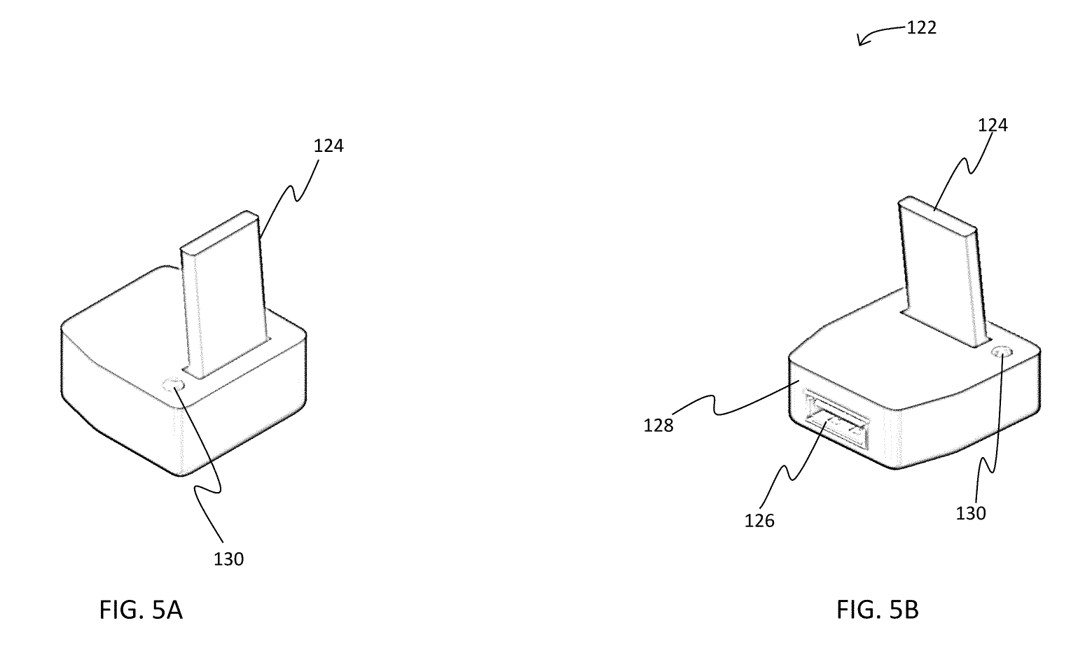

As shown in FIGS. 1-5B, eyewear piece 110 may include slot 112 configured to house an SD card, with eyewear piece 110 including plurality of lights 114 located on the front side of eyewear piece 110. Handheld controller 118 may include plurality of buttons 120 configured to control multiple play modes of movies and/or video games. Charging station 122 may be configured to charge battery 124 of virtual reality system 100 and may also include USB port 126 located on/in a back side of charging station 122, with charging station 122 having charging indicator light(s) 130 located on a top surface of charging station 122 configured to provide a charge status of battery 124.

Plurality of lights 114 may include various colors and indictors. As such, a red light may be configured to indicate when the power source is being supplied to eyewear piece 110, a green light configured to indicate a relative level of battery life of eyewear piece 110 remaining, a light blue light configured to indicate a wireless (e.g., BLUETOOTH, etc.) connection, and a dark blue light configured to indicate a Wi-Fi connection. The wireless connection may wirelessly connect to external devices such as headphones or other suitable devices worn and/or used by user 40 and/or an individual other than the user of eyewear piece 110.

The SD card may contain accessible storage (i.e., for memory storage) for video and games. Therefore, virtual reality system may be configured to allow a user to watch movies, listen to music, and play video games from the memory storage and/or via a streaming connection. Also, virtual reality system may further include plurality of gloves 132, plurality of gloves 132 each having a plurality of glove-sensors 134, with plurality of glove-sensors 134 located in a plurality of finger portions 136 and the palms of the gloves 132 configured to be used with eyewear piece 110 while watching movies and/or playing games. Virtual reality system 100 may further include scanner 138, with scanner 138 including a plurality of scanner-sensors 140 and light 142 wherein scanner-sensors 140 are configured to engage glove-sensors 134 electronically and/or visually/optically. Those with ordinary skill in the art will now appreciate that upon reading this specification and by their understanding the art of optics and electronics as described herein, methods of using a virtual reality system will be understood by those knowledgeable in such art.

Eyewear piece 110 may include plurality of internal speakers 144 housed within eyewear piece 110 and be configured to allow sound to reach the user. Also, eyewear piece 110 may include plurality of buttons 120. As such, plurality of buttons 120 may include rewind button 146, fast-forward 148 button, pause button 150, stop button 152, a previous button (not shown), and next-button 156. Eyewear piece 110 may be adjustable to fit the size of a head of any user. Further, eyewear piece 110 may include compartment 158 on the back side of eyewear piece 110 configured to house battery 124.

Eyewear piece 110 may include outside monitor 160 configured to allow individuals other than the user of eyewear piece 110 to watch movies, listen to music, and/or play video games. Similarly, eyewear piece 110 may include external speaker 166 configured to allow individuals other than user of said eyewear piece 110 to listen to sound of movies, music, and video games. Eyewear piece 110 may also include microphone 168, with microphone 168 configured to allow the user to interact with the video games. Eyewear piece 110 may be connectable to an internet either by wireless capabilities and/or a wired connection. Also, device 110 may include the ability to download and save mobile or software applications.

Upon reading this specification, it should be appreciated that, under appropriate circumstances, considering such issues as user preferences, design preference, structural requirements, marketing preferences, cost, available materials, technological advances, etc., other optical and structural arrangements such as, for example, hardware, software, viewing angles, etc., may be sufficient.

Eyewear piece 110 may include camera 170 located on the front side of eyewear piece 110 configured to take pictures and/or video. Handheld controller 118 may be wirelessly connected to eyewear piece 110, in embodiments. Alternate embodiments may include wired connections. Eyewear piece 110 may include eject button 172 located on the top surface of eyewear piece 110, configured to eject the SD card. Eyewear piece 110 may also include a plurality of dimmer controls. The plurality of dimmer controls may include plus button 162 and minus button 164 configured to adjust a relative intensity of brightness of the monitor.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A virtual reality system for watching movies and playing video games, said virtual reality system comprising:
an eyewear piece, said eyewear piece having a slot configured to house an SD card, wherein said eyewear piece has a plurality of lights located on a front side of said eyewear piece;
a handheld controller, said handheld controller having a plurality of buttons configured to control multiple play modes of said movies and said video games;
a charging station, said charging station configured to charge a battery of said virtual reality system and having a USB port located in a back side of said charging station, wherein said charging station has a charging indicator light located on a top surface of said charging station configured to provide a charge status of said battery;
wherein said SD card contains accessible storage for said movies and said video games; and
wherein said virtual reality system is configured to allow a user to watch movies and play video games.

2. The virtual reality system of claim 1, wherein said system further comprises a pair of gloves, said pair of gloves having a plurality of glove-sensors, wherein said plurality of glove-sensors is located in a plurality of finger portions of said pair of gloves configured to be used with said eyewear piece while watching said movies and playing said video games.

3. The virtual reality system of claim 2, wherein said system further comprises a scanner, said scanner including a plurality of scanner-sensors and a light wherein said scanner-sensors are configured to engage said glove-sensors.

4. The virtual reality system of claim 1, wherein said eyewear piece further comprises a plurality of internal speakers housed within said eyewear piece and configured to allow sound to reach the user.

5. The virtual reality system of claim 1, wherein said eyewear piece includes a plurality of control buttons.

6. The virtual reality system of claim 4, wherein said plurality of control buttons includes a rewind button, a fast-forward button, a pause button, a stop button, a previous button, and a next-button.

7. The virtual reality system of claim 1, wherein said eyewear piece is adjustable to fit the size of a head of said user.

8. The virtual reality system of claim 1, wherein said eyewear piece has a compartment in a back side of said eyewear piece configured to house said battery.

9. The virtual reality system of claim 1, wherein said eyewear includes an outside monitor configured to allow individuals to watch said movies and said video games.

10. The virtual reality system of claim 1, wherein said plurality of lights includes a red light configured to indicate when a power source is being supplied to said eyewear piece, a green light configured to indicate a relative level of battery life of said eyewear piece remaining, a light blue light configured to indicate a Bluetooth connection, and a dark blue light configured to indicate a Wi-Fi connection.

11. The virtual reality system of claim 1, wherein said eyewear piece includes a plurality of dimmer controls.

12. The virtual reality system of claim 10, wherein said plurality of dimmer controls includes a plus button and a minus button configured to adjust a relative intensity of brightness of said monitor.

13. The virtual reality system of claim 1, wherein said eyewear piece includes an external speaker configured to allow individuals to listen to sound of said movies and said video games.

14. The virtual reality system of claim 1, wherein said eyewear piece includes a microphone, said microphone configured to allow said user to interact with said video games.

15. The virtual reality system of claim 1, wherein said eyewear piece includes a camera located on said front side of said eyewear piece configured to take pictures.

16. The virtual reality system of claim 1, wherein said handheld controller is wirelessly connected to said eyewear piece.

17. A virtual reality system of claim 1, wherein said eyewear piece includes an eject button located on a top surface of said eyewear piece and configured to eject said SD card.

18. A virtual reality system for watching movies and playing video games, said virtual reality system comprising:
an eyewear piece, said eyewear piece having a slot configured to house an SD card, wherein said eyewear piece has a plurality of lights located on a front side of said eyewear piece;
a handheld controller, said handheld controller having a plurality of buttons configured to control multiple play modes of said movies and said video games;
a charging station, said charging station configured to charge at least one battery of said virtual reality system and having a USB port located in a back side of said charging station, wherein said charging station has a charging indicator light located on a top surface of said charging station and configured to provide a charge status of said battery;
wherein said SD card contains said movies and said video games;
wherein said virtual reality system is configured to allow a user to watch said movies and play said video games;
wherein said SD card player includes a stand removably attached to a top of said SD card player and wherein said stand includes a plurality of stand-sensors and a light;
wherein said eyewear piece further comprises a plurality of internal speakers housed within said eyewear piece and configured to allow sound to reach the user;
wherein said eyewear piece includes a plurality of control buttons;
wherein said plurality of control buttons includes a rewind button, a fast-forward button, a pause button, a stop button, a previous button, and a next button
wherein said eyewear piece is adjustable to fit a size of a head of said user;
wherein said eyewear piece has a compartment in a back side of said eyewear piece configured to house said battery;
wherein said eyewear piece includes an outside monitor configured to allow people other than said user of said eyewear piece to watch said movies and video games;
wherein said plurality of lights includes a red light configured to indicate when a power source is being supplied to said eyewear piece, a green light configured to indicate a battery life of said eyewear piece, a light blue light configured to indicate a Bluetooth connection, and a dark blue light configured to indicate a Wi-Fi connection;
wherein said eyewear piece includes a plurality of dimmer controls;
wherein said plurality of dimmer controls includes a plus button and a minus button configured to adjust an intensity of brightness of said monitor;
wherein said eyewear piece includes an external speaker configured to allow people other than said user of said eyewear piece to listen to a sound of said movies and said video games;
wherein said eyewear piece includes a microphone, said microphone configured to allow said user to interact with said video games;
wherein said eyewear piece includes a camera located on said front side of said eyewear piece and configured to take pictures;
wherein said handheld controller is wirelessly connected to said eyewear piece; and
wherein said eyewear piece includes an eject button located on said top surface of said eyewear piece and is configured to eject said SD card.

19. The virtual reality system of claim 18, further comprising set of instructions; and
wherein the virtual reality system is arranged as a kit.
